(19) United States
(12) Patent Application Publication
(10) Pub. No.: US 2022/0404979 A1
(43) Pub. Date: Dec. 22, 2022

(54) MANAGING QUEUES OF A MEMORY SUB-SYSTEM

(71) Applicant: Micron Technology, Inc., Boise, ID (US)

(72) Inventors: Jiangang Wu, Milpitas, CA (US); Jing Sang Liu, Shanghai (CN); Yun Li, Fremont, CA (US); James P. Crowley, Longmont, CO (US)

(21) Appl. No.: 16/954,156

(22) PCT Filed: Mar. 10, 2020
(86) PCT No.: PCT/CN2020/078604

§ 371 Date: Jun. 16, 2020

(51) Int. Cl. G06F 3/06

(52) U.S. Cl. CPC G06F 3/0613; G06F 3/0679; G06F 3/0659

(57) ABSTRACT

Methods, systems, and devices for managing queues of a memory sub-system are described. A first command can be assigned to a first queue of a memory die of a memory sub-system. The first queue can be is associated with a first priority level and the memory die can include a second queue associated with a second priority level different from the first priority level. The second queue can include a second command, where the first command and the second command are each associated with a respective operation to be performed on the memory sub-system. In some examples, the first command can be issued before the second command based on the first and second priority levels.

### CROSS REFERENCE

The present application for patent is a 371 national phase filing of International Patent Application No. PCT/CN2020/078604 by Wu et al., entitled “MANAGING QUEUES OF A MEMORY SUB-SYSTEM,” filed Mar. 10, 2020, assigned to the assignee hereof, and expressly incorporated by reference herein.

### TECHNICAL FIELD

The following relates generally to a memory sub-system and more specifically to managing queues of a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory components.

### BRIEF DESCRIPTION OF THE DRAWINGS

The disclosure will be understood more fully from the detailed description given below and from the accompanying drawings of various examples of the disclosure. The drawings, however, should not be taken to limit the disclosure to the specific examples, but are for explanation and understanding only.

FIG. 1 illustrates an example computing system that includes a memory sub-system in accordance with some examples of the present disclosure.

FIG. 2 is a flow diagram of an example method to manage queues of a memory sub-system in accordance with some examples of the present disclosure.

FIG. 3A is an example of a firmware queue of a memory sub-system in accordance with some examples of the present disclosure.

FIG. 3B is an example of a global pool for a memory controller in accordance with some examples of the present disclosure.

FIG. 4 is an example of a memory system for managing queues in accordance with some examples of the present disclosure.

FIG. 5 is a block diagram of an example computer system in which examples of the present disclosure can operate.

### DETAILED DESCRIPTION

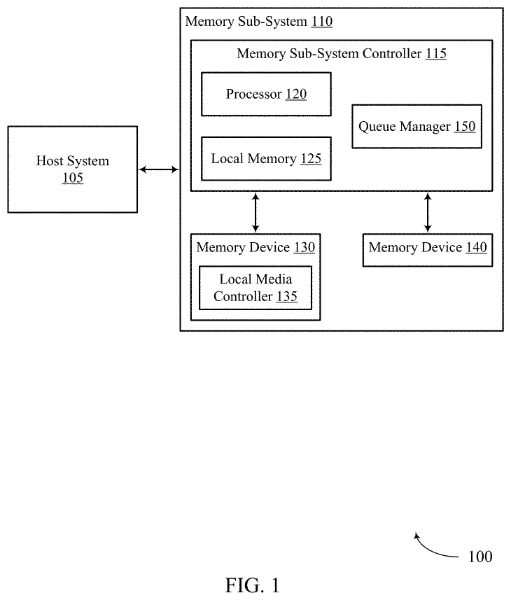

Aspects of the present disclosure are directed to managing queues of a memory sub-system. A memory sub-system can be a storage device, a memory module, or a hybrid of a storage device and memory module. Examples of storage devices and memory modules are described herein in conjunction with FIG. 1. In general, a host system can utilize a memory sub-system that includes one or more components, such memory devices that store data. The host system can provide data to be stored at the memory sub-system and can request data to be retrieved from the memory sub-system.

A memory device can be a non-volatile memory device. One example of non-volatile memory devices is a negative-and (NAND) memory device. Other examples of non-volatile memory devices are described below in conjunction with FIG. 1. A non-volatile memory device is a package of one or more dice. Each die can consist of one or more planes. Planes can be groups into logic units (LUN). For some types of non-volatile memory devices (e.g., NAND devices), each plane consists of a set of physical blocks. Each block consists of a set of pages. Each page consists of a set of memory cells (“cells”). A cell is an electronic circuit that stores information. A data block hereinafter refers to a unit of the memory device used to store data and can include a group of memory cells, a word line group, a word line, or individual memory cells.

Data operations can be performed by the memory sub-system. The data operations can be host-initiated operations. For example, the host system can initiate a data operation (e.g., write, read, erase, etc.) on a memory sub-system. The host system can send access requests (e.g., write command, read command) to the memory sub-system, such as to store data on a memory device at the memory sub-system and to read data from the memory device on the memory sub-system.

In traditional access operations of NAND cells, commands can be constantly transmitted to various memory dies. The commands can be associated with different access operations (e.g., read operations, write operations, etc.) having varying levels of priority. That is, it can be desirable for a host read command to be transmitted to a particular memory die before a read command or write command is transmitted to the same die. However, because memory sub-systems include many dies, and each die can be associated with a multitude commands and command types, traditional access operations can be unable to effectively prioritize transmitting commands. Accordingly, traditional access operations can result in backpressure on a local memory controller of a memory device (e.g., due to a backlog of commands to be issued), which can tie up resources needed by the memory sub-system to issue commands.

Aspects of the present disclosure address the above and other deficiencies by managing queues of a memory sub-system at a die level. For example, each memory die of a memory sub-system can be associated with a queue (e.g., a memory die queue) for managing commands associated with the respective die. Further, each memory die queue can include multiple sub-queues (e.g., priority queues) for managing commands associated with particular priority levels. When a command associated with a memory die is received, an associated request (e.g., a request for the command) can be assigned to the associated memory die queue (and to the relevant priority queue) for issuance. Based on the priority level associated with the command, it can be issued by a local memory controller.

For example, a memory die queue associated with a particular memory die of a memory sub-system can include one or more (e.g., two, three, six) priority queues. Each priority queue can be associated with (e.g., reserved for) commands associated with a particular priority level. If three queues are used, for instance, a first priority queue can be associated with commands having a first (e.g., a highest; a most-urgent) priority level, a second priority queue can be associated with commands having a second (e.g., an intermediate; a middle) priority level, and a third priority queue can be associated with commands having a third (e.g., a lowest; a least-urgent) priority level. When a command for the memory die is received, it can be assigned to a priority queue based on its associated priority level, which can be predefined or otherwise configured (e.g., semi-persistently, dynamically). For issuance, commands in a higher priority queue can be issued before commands in a lower priority queue—i.e., a command in the first priority queue can be issued before a command in the second priority queue. Further, when a command is assigned to a higher-priority queue when commands from a lower-priority queue are being issued, the issuance of the commands in the lower-priority queue can be temporarily paused in order for the higher-priority command to be issued. Once the higher-priority command is issued, the issuance of the commands in the lower-priority queue can resume. Such techniques can be performed die-by-die (e.g., each memory die can include respective sets of queues (e.g., multiple queues for each memory die)), which can reduce backpressure that a local memory controller can otherwise incur, allowing the memory sub-system to issue commands based on available resources.

FIG. 1 illustrates an example of a computing system 100 that includes memory sub-system 110 in accordance with some embodiments of the present disclosure. The memory sub-system 110 can include media, such as one or more non-volatile memory devices (e.g., memory device 130), one or more volatile memory devices (e.g., memory device 140), or a combination thereof.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMMM (SO-DIMM), and various types of non-volatile DIMM (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 105 that is coupled with one or more memory systems 110. In some examples, the host system 105 is coupled with different types of memory systems 110. FIG. 1 illustrates one example of a host system 105 coupled with one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 105 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 105 uses the memory sub-system 110, for example, to write data to the memory sub-system 110 and read data from the memory sub-system 110.

The host system 105 can be coupled to the memory sub-system 110 using a physical host interface. Examples of a physical host interface include, but are not limited to, a serial advanced technology attachment (SATA) interface, a peripheral component interconnect express (PCIe) interface, USB interface, Fiber Channel, Small Computer System Interface (SCSI), Serial Attached SCSI (SAS), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 105 and the memory sub-system 110. The host system 105 can further utilize a non-volatile memory Express (NVMe) interface to access components (e.g., memory devices 130) when the memory sub-system 110 is coupled with the host system 105 by the PCIe interface. The physical host interface can provide an interface for passing control, address, data, and other signals between the memory sub-system 110 and the host system 105. FIG. 1 illustrates a memory sub-system 110 as an example. In general, the host system 105 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic RAM (DRAM) and synchronous DRAM (SDRAM).

Some examples of non-volatile memory devices (e.g., memory device 130) include negative-and (NAND) type flash memory and write-in-place memory, such as three-dimensional cross-point (“3D cross-point”) memory, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as NAND type flash memory (e.g., 2D NAND, 3D NAND) and 3D cross-point array of non-volatile memory cells are described, the memory device 130 can be based on any other type of non-volatile memory, such as ROM, phase change memory (PCM), self-selecting memory, other chalcogenide based memories, ferroelectric transistor random-access memory (FeTRAM), ferroelectric RAM (FeRAM), magneto RAM (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable ROM (EEPROM).

The memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The memory sub-system controller 115 can be a microcontroller, special purpose logic circuitry (e.g., a field programmable gate array (FPGA), an application specific integrated circuit (ASIC), digital signal processor (DSP)), or another suitable processor.

The memory sub-system controller 115 can include a processor 120 (e.g., a processing device) configured to execute instructions stored in a local memory 125. In the illustrated example, the local memory 125 of the memory sub-system controller 115 includes an embedded memory configured to store instructions for performing various processes, operations, logic flows, and routines that control operation of the memory sub-system 110, including handling communications between the memory sub-system 110 and the host system 105.

In some examples, the local memory 125 can include memory registers storing memory pointers, fetched data, etc. The local memory 125 can also include ROM for storing micro-code. While the example memory sub-system 110 in FIG. 1 has been illustrated as including the memory sub-system controller 115, in another example of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 105 and can convert the commands or operations into instructions or appropriate commands to achieve the desired access to the memory devices 130 and/or the memory device 140. The memory sub-system controller 115 can be responsible for other operations such as wear leveling operations, garbage collection procedures, error detection and error-correcting code (ECC) operations, encryption operations, caching operations, and address translations between a logical address (e.g., logical block address (LBA), namespace) and a physical address (e.g., physical block address) that are associated with the memory devices 130. The memory sub-system controller 115 can further include host interface circuitry to communicate with the host system 105 via the physical host interface. The host interface circuitry can convert the commands received from the host system into command instructions to access the memory devices 130 and/or the memory device 140 as well as convert responses associated with the memory devices 130 and/or the memory device 140 into information for the host system 105.

The memory sub-system 110 can also include additional circuitry or components that are not illustrated. In some examples, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some examples, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local controller 135) for media management within the same memory device package. An example of a managed memory device is a managed NAND (MNAND) device.

The memory sub-system 110 includes a queue manager 150 that manages commands according to an associated priority level. For example, each memory die (e.g., memory device 130, memory device 140) of a memory sub-system 110 can be associated with a memory die queue. The memory die queues can each include one or more priority queues where commands (e.g., read commands, write commands, host read commands, etc.) are allocated for issuance. When a command associated with a particular die is received, the queue manager 150 can determine a priority level associated with the command (e.g., the queue manager 150 can determine a type of the command) and allocate the command to a priority queue associated with the die. Commands may be issued from respective priority queues based on the associated priority levels. Using such techniques, commands associated with queues having a higher priority level can be issued before commands associated with queues having relatively lower priority levels. The commands can be issued on a die-by-die level (e.g., higher priority commands of a die are issued before lower priority commands of the same die) or globally (e.g., higher priority commands are issued before lower priority commands regardless of the memory die). In either example, issuing commands according to a priority level of the respective command can reduce backpressure that a memory sub-system controller 115 can incur, allowing the memory sub-system 110 to issue commands based on available resources.

In some examples, the memory sub-system controller 115 includes at least a portion of the queue manager 150. For example, the memory sub-system controller 115 can include a processor 120 (e.g., a processing device) configured to execute instructions stored in local memory 125 for performing the operations described herein. In some examples, the queue manager 150 is part of the host system 105, an application, or an operating system.

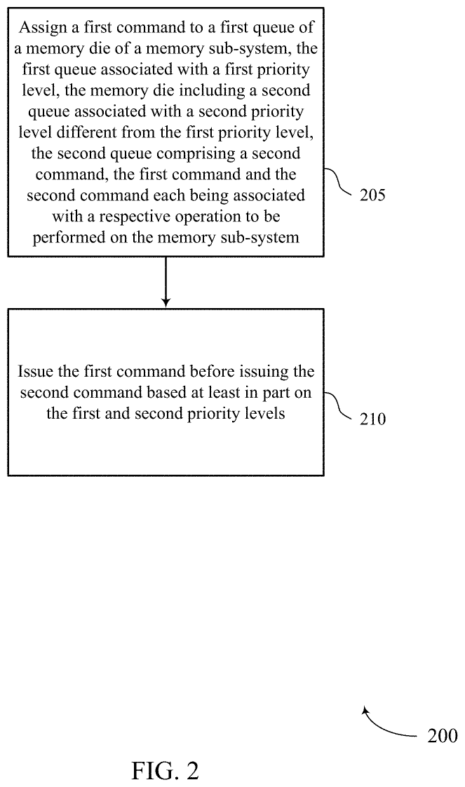

FIG. 2 is a flow diagram of an example method 200 for managing queues of a memory sub-system in accordance with some examples of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some examples, the method 200 is performed by the queue manager 150 of FIG. 1. Although shown in a particular sequence or order, unless otherwise specified, the order of the processes can be modified. Thus, the illustrated examples should be understood only as examples, and the illustrated processes can be performed in a different order, and some processes can be performed in parallel. Additionally, one or more processes can be omitted in various examples. Thus, not all processes are required in every example. Other method flows are possible.

At operation 205, the processing device can assign a first command to a first queue of a memory die of a memory sub-system, such as memory sub-system 110 of FIG. 1. The first queue can be associated with a first priority level and the memory die can include a second queue associated with a second priority level different from the first priority level. The second queue can include a second command and the first command and the second command can each be associated with a respective operation to be performed on the memory sub-system.

At operation 210, the processing device can issue the first command before issuing the second command based at least in part on the first and second priority levels.

In some examples, the method 200 can include issuing one or more second commands in the second queue before assigning the first command to the first queue and suspending issuing of the one or more second commands in the second queue based at least in part on assigning the first command to the first queue. In some examples, issuing the first command is based at least in part on suspending issuing of the one or more second commands.

In some examples, the method 200 can include resuming issuing the one or more second commands in the second queue after issuing the first command.

In some examples, the method 200 can include assigning an additional first command to the first queue after resuming issuing the one or more second commands in the second queue, suspending issuing the one or more second commands in the second queue based at least in part on assigning the additional first command to the first queue, issuing the additional first command based at least in part on suspending the one or more second commands, and resuming issuing the one or more second commands in the second queue after issuing the additional first command.

In some examples, the first queue includes one or more additional commands and the method 200 can include issuing, based at least in part on assigning the first command, the one or more additional commands before issuing the one or more second commands in the second queue.

In some examples, the method 200 can include assigning first commands to a plurality of first queues of a plurality of memory dies of the memory sub-system and issuing each of the first commands before issuing commands in respective second queues of the plurality of memory dies based at least in part on the first and second priority levels. In some examples, each of the plurality of first queues is associated with the first priority level and each of the plurality of memory dies includes a respective second queue associated with the second priority level.

In some examples, the method 200 can include determining an amount of resources available to the memory sub-system. In some examples, issuing the first command before issuing the one or more second commands in the second queue is based at least in part on the amount of resources available to the memory sub-system.

In some examples of the method 200, the first command comprises a host read command, and wherein the one or more second commands comprise a host write command, a read command, a write command, an erase command, or a combination thereof.

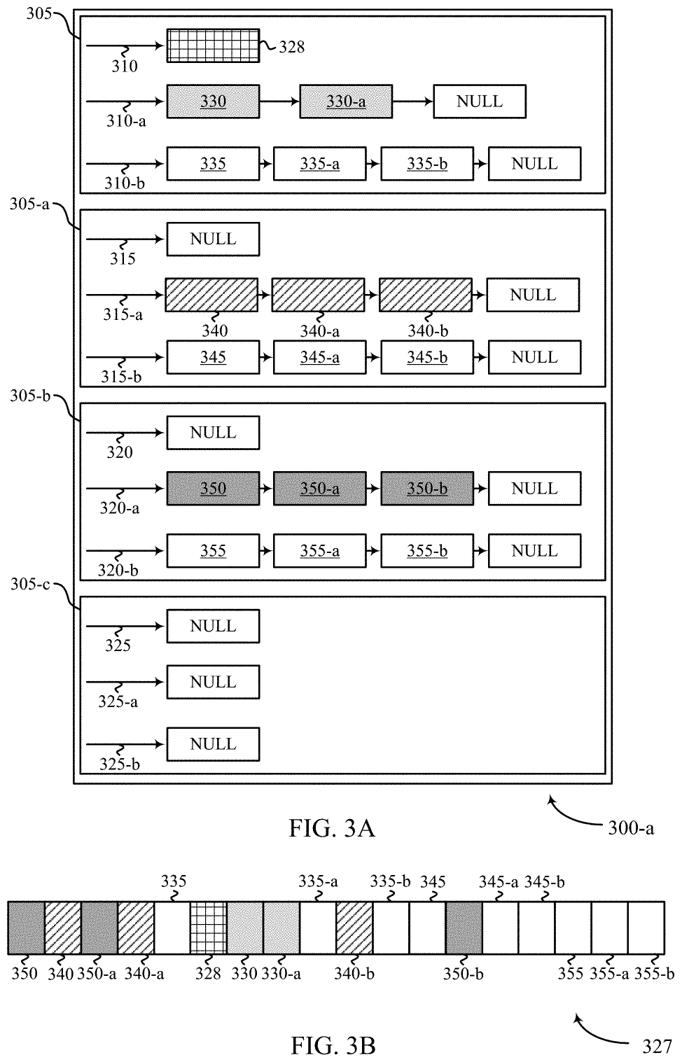

FIG. 3A illustrates an example of a firmware queue 300-a that supports managing queues of a memory sub-system in accordance with some examples of the present disclosure. The firmware queue 300-a illustrates a plurality of memory die queues 305 (e.g., LUN queues 305) that each include one or more priority queues. For example, a first memory die queue 305 can include priority queues 310, 310-a, and 310-b. In some examples, priority queue 310 can correspond to a first priority queue, priority queue 310-a can correspond to a second priority queue, and priority queue 310-b can correspond to a third priority queue. The priority queues 310 can include particular commands (e.g., requests to complete commands), and the commands can be issued by a local memory controller (e.g., a flash memory controller) according to the priority level of the respective queue 310. In some examples, commands can be assigned to a queue 310 on-the-fly, which may result in the issuance of other commands (associated with different priority levels) being temporarily suspended. Incorporating queues at a memory die level can reduce backpressure that a local memory controller can incur, allowing for the sub-system to issue commands based on available resources.

As discussed herein, the memory die queue 305 can include priority queues 310, 310-a, and 310-b, which may correspond to a first priority queue, a second priority queue, and a third priority queue, respectively. In some examples, the first priority queue 310 can be assigned a highest priority level (e.g., relative to the second and third priority queues). By assigning the priority queue 310 a highest priority level, any command pertaining to the associated memory die that is placed in the priority queue 310 can be issued (e.g., sent to a local memory controller) before commands in the priority queues 310-a and 310-b. Similarly, the second priority queue 310-a can be assigned an intermediate priority level (e.g., relative to the first and third priority queues). By assigning the priority queue 310-a an intermediate priority level, any command pertaining to the associated memory die that is placed in the priority queue 310-a can be issued before commands in the priority queue 310-b. In other examples, the third priority queue 310-b can be assigned a lowest priority level (e.g., relative to the first and second priority queues). By assigning the priority queue 310-b a lowest priority level, any command pertaining to the associated memory die that is placed in the priority queue 310-b can be issued only when priority queues 310 and 310-a are empty (e.g., they do not contain any commands).

By way of example, the first memory die queue 305 can include command 328 in the priority queue 310 and commands 330 and 330-a in the priority queue 310-a. The first memory die queue 305 can also include commands 335, 335-a, and 335-b in the priority queue 310-b. In some examples, each of the commands in the priority queues 310, 310-a, and 310-b can be different commands that are received at different times. That is, commands can be entered into the priority queues 310, 310-a, and 310-b as they are issued. Accordingly, because the priority queue 310 can be associated with a higher priority level than the priority queues 310-a and 310-b, the command 328 can be issued before the commands 330, 330-a, 335, 335-a, and 335-b.

Additionally or alternatively, one or more of the commands 335, 335-a, and 335-b can be entered into the priority queue 310-b before the commands 328, 330, and/or 330-a are entered into the priority queues 310 and 310-a, respectively. The commands in the priority queue 310-b can be issued (e.g., individually; one-by-one) until a command is entered into either of the priority queue 310 or the priority queue 310-a. When a command is entered into either of the priority queues 310 or 310-a, commands in the priority queue 310-b may not be issued. That is, any commands in the priority queue 310-b can be paused (e.g., placed on hold; suspended) until all commands in the priority queues 310 and/or 310-a are issued. Upon issuing all commands in the priority queues 310 and/or 310-a, any commands in the priority queue 310-b can be issued (or continue being issued). Similarly, commands in the priority queue 310 can be prioritized over commands in the priority queue 310-a. Accordingly, any commands in the priority queue 310-a can be paused (e.g., placed on hold; suspended) until all commands in the priority queue 310 are issued. When commands are satisfied (e.g., the requests from the queues are passed to a local memory controller), the associated command can be entered into a global pool shown in FIG. 3B. Commands in the global pool can be issued by a local memory controller.

In some examples, the second memory die queue 305-a can include commands 340, 340-a, and 340-b in the priority queue 315-a. The second memory die queue 305-a can also include commands 345, 345-a, and 345-b in the priority queue 315-b. As shown in FIG. 3A the priority queue 315 can be temporarily empty (e.g., NULL), but can receive one or more commands (e.g., at a subsequent time; at a different time than shown). In some examples, each of the commands in the priority queues 315-a and 315-b can be different commands that are received at different times. That is, commands can be entered into the priority queues 315-a and 315-b as they are issued. In some examples, the commands can be entered at a same or different time than the commands entered into the priority queues 310-a and 310-b of the first memory die queue 305. Because the priority queue 315-a can be associated with a higher priority level than the priority queue 315-b, the commands 340, 340-a, and 340-b can be issued before the commands 345, 345-a, and 345-b.

As discussed above with respect to the memory die queue 305, one or more of the commands 345, 345-a, and 345-b can be entered into the priority queue 315-b before the commands 340, 340-a and/or 340-b are entered into the priority queue 315-a. The commands in the commands in the priority queue 315-b can be issued (e.g., individually; one-by-one) until a command is entered into the priority queue 315-a. When a command is entered into the priority queue 315-a, commands in the priority queue 315-b may not be issued. That is, any commands in the priority queue 315-b can be paused (e.g., placed on hold; suspended) until all commands in the priority queue 315-a are issued. Upon issuing all commands in the priority queue 315-a, any commands in the priority queue 315-b can be issued (or continue being issued). As discussed herein, when commands (e.g., the requests for the commands) are issued from a queue, they can be entered into a global pool shown in FIG. 3B. Commands in the global pool can be issued by a local memory controller.

In some examples, commands may be entered into corresponding priority queues of different memory die queues. For example, the memory die queue 305 and the memory die queue 305-a can both include first, second, and third priority queues. Accordingly, commands can be issued from corresponding priority queues of different memory die queues either on a die-by-die basis or globally (e.g., based on corresponding priority queues of different memory die queues). For example, the priority queue 310-a can include commands 330 and 330-a, and the priority queue 315-a can include commands 340, 340-a, and 340-b. Because, at any one time, both priority queues can include one or more of the commands, the commands can either be issued on a die-by-die basis—e.g., memory die queue 305 can issue commands according to its own priority queues and memory die queue 305-a can issue commands according to its own priority queues). Or the respective commands can be issued based on an order that the commands were entered into the respective priority queues—e.g., commands 330, 330-a, 340, 340-a, and 340-b can be issued based on the order that each command was entered into the respective priority queue because each command is associated with a same priority level.

In some examples, the firmware queue 300-a can also include a third memory die queue 305-b and a fourth memory die queue 305-c. The fourth memory die queue 305 can also be or represent an nth memory die queue of the firmware queue 300-a. That is, the firmware queue 300-a can include a plurality of memory die queues that correspond to the memory dies of the memory sub-system. In some examples, the third memory die queue 305-b and fourth memory die queue 305-b can each include one or more priority queues for commands. For example, the third memory die queue 305-b can include commands 350, 350-a, and 350-b in the priority queue 320-a and commands 355, 355-a, and 355-b in the priority queue 320-b. As shown in FIG. 3A the priority queues of the fourth memory die queue 305-c can be temporarily empty (e.g., NULL), but can receive one or more commands (e.g., at later time; at a different time).

As discussed with reference to memory die queues 305 and 305-a, the memory die queues 305-b and 305-c can issue commands according to the priority levels associated with the respective priority queues. For example, commands 350, 350-a, and 350-b can be issued before commands 355, 355-a, and 355-b due to the priority level associated with the priority queue 320-a. In other examples, and as discussed herein, issuance of the commands 355, 355-a, and 355-b may be temporarily suspended (e.g., paused; put on hold) when commands are assigned to the priority queue 320-a. Upon the issuance of any commands in the priority queue 320-a, the issuance of commands in the priority queue 320-b (e.g., commands 355, 355-a, and/or 355-b) may resume. Additionally or alternatively, commands associated with the third memory die queue 305-b and/or the fourth memory die queue 305-c can be issued on a die-by-die basis or globally (e.g., based on corresponding priority queues of different memory die queues).

In some examples, particular commands can be associated with predefined priority levels. For example, a first priority level (e.g., a highest priority level) can be associated with a host read command. That is, each time a host read associated with a particular memory die is issued, it can be assigned to the first priority queue of the memory die queue associated with the particular die. In other examples, a first priority level (e.g., an intermediate priority level) can be associated with a host write command, a read command, a write command, an erase command, or a combination thereof. All other types of commands can be associated with a third (or lower) priority level.

FIG. 3B illustrates an example of a global pool 327 in accordance with some examples of the present disclosure. The global pool 327 may include one or more commands from the priority queues discussed with reference to FIG. 3A. That is, requests to complete commands may be issued (e.g., released) from the priority queues to the global pool 327, and a local memory controller may issue an associated command based on the order in which they are entered into the global pool 327. Issuing the commands from the global pool 327 in an order received (i.e., according to the time the commands were received and the respective priority of each command) can reduce backpressure that the local memory controller can incur, and allows the sub-system to issue commands based on available resources.

In some examples, the global pool 327 can include each of the commands discussed with reference to FIG. 3A. The commands can be entered into (e.g., included in) the global pool 327 based on an order received (e.g., by the respective memory die queue 305), a respective priority level associated with the command, or both. In some examples, the commands in the global pool 327 can correspond to one or more resources (e.g., a memory address) associated with the command. That is, the commands in the global pool 327 can be issued by a local memory controller to access a particular memory cell or group of memory cells.

The global pool 327 can include commands from each of the memory die queues 305 discussed with reference to FIG. 3A. For example, commands 328, 330, 303-a, 335, 335-a, and 335-b from the first memory die queue 305 can be included in the global pool 327. Additionally or alternatively, commands 340, 340-a, 340-b, 345, 345-a, and 345-b from the second memory die queue 305-a can be included, as well as commands 350, 350-a, 350-b, 355, 355-a, and 355-b from the second memory die queue 305-b. The commands can be entered into the global pool 327 based on an order received at the respective memory die queue 305, based on a respective priority level associated with the command, or both.

In some examples, command 350 from the second priority queue 320-a of the third memory die queue 305-b can be the first command in the global pool 327. The command 350 can be the first command entered into the global pool 327 due to it being received before any commands associated with a higher priority (e.g., command 328). In some examples, the command 350 can be entered into the global pool 327 before other commands associated with a same priority level (e.g., commands 330, 330-a, 340, 340-a, 340-b, 350-a, and/or 350-b) due to the command 350 being received first. Stated another way, the second priority queue 320-a can receive and the command 350 before any other memory die queues receive and issue a command with a same (or higher) priority level.

In some examples, command 340 from the second priority queue 315-a of the second memory die queue 305-a can be the next (e.g., the second) command in the global pool 327. The command 340 can be entered into the global pool based on it being received after the command 350 but before any commands associated with a higher priority (e.g., command 328). In some examples, the command 340 can be entered into the global pool 327 before other commands associated with a same priority level (e.g., commands 330, 330-a, 340, 340-a, 340-b, 350-a, and/or 350-b) due to the command 340 being received first.

In some examples, command 350-a from the second priority queue 320-a of the third memory die queue 305-b can be the next command in the global pool 327. The command 350-a can be entered into the global pool based on it being received after the command 340 but before any commands associated with a higher priority (e.g., command 328). In some examples, the command 350-a can be entered into the global pool 327 before other commands associated with a same priority level (e.g., commands 330, 330-a, 340-a, 340-b, 350-a, and/or 350-b) due to the command 350-a being received first.

In some examples, command 340-a from the second priority queue 315-a of the second memory die queue 305-a can be the next command in the global pool 327. The command 340-a can be entered into the global pool based on it being received after the command 350-a but before any commands associated with a higher priority (e.g., command 328). In some examples, the command 340-a can be entered into the global pool 327 before other commands associated with a same priority level (e.g., commands 330, 330-a, 340-a, 340-b, and/or 350-b) due to the command 350-a being received first.

In some examples, command 335 from the third priority queue 310-b of the first memory die queue 305 can be the next command in the global pool 327. The command 335 can be entered into the global pool based on it being received when no other memory die queues include higher-priority commands. In some examples, the command 335 can be entered into the global pool 327 before other commands associated with a same priority level (e.g., commands 335-a, 335-b, 345, 345-a, 345-b, 355, 355-a, and/or 355-b) due to the command 335 being received first.

In some examples, command 328 from the first priority queue 310 of the first memory die queue 305 can be the next command in the global pool 327. The command 328 can be entered into the global pool based on its priority alone. For example, because the command 328 is associated with a first (e.g., a highest priority), it can be entered into the global pool 327 even if other memory die queues include commands in respective priority queues. For example, the first memory die queue 305 can include commands 330 and 330-a in the second priority queue 310-a. However, due to the priority of the command 328, the command 328 may be issued first (e.g., before commands 330 and 330-a).

In some examples, commands 330 and 330-a from the second priority queue 310-a of the first memory die queue 305 can be the next commands in the global pool 327. The commands 330 and 330-a can be entered into the global pool based on them being received after the command 328 but before any commands associated with a higher priority (e.g., another command in a first priority queue). In some examples, the commands 330 and 330-a can be entered into the global pool 327 before other commands associated with a same priority level (e.g., commands 340-a, 340-b, and/or 350-b) due to the commands 330 and 330-a being received first.

In some examples, command 335-a from the third priority queue 310-b of the first memory die queue 305 can be the next command in the global pool 327. The command 335 can be entered into the global pool based on it being received when no other memory die queues include higher-priority commands. In some examples, the command 335-a can be entered into the global pool 327 before other commands associated with a same priority level (e.g., commands 335-b, 345, 345-a, 345-b, 355, 355-a, and/or 355-b) due to the command 335-a being received first.

In some examples, command 340-b from the second priority queue 315-a of the second memory die queue 305-a can be the next command in the global pool 327. The command 340-b can be entered into the global pool based on it being received after the command 335-a but before any commands associated with a higher priority (e.g., another command in a first priority queue). In some examples, the command 340-b can be entered into the global pool 327 before other commands associated with a same priority level (e.g., command 350-b) due to the command 340-b being received first.

In some examples, commands 335-b and 345 from the third priority queues 310-b and 315-b can be the next commands in the global pool 327. The commands 335-b and 345 can be entered into the global pool based on them being received when no other memory die queues include higher-priority commands. In some examples, the commands 335-b and 345 can be entered into the global pool 327 before other commands associated with a same priority level (e.g., commands 345-a, 345-b, 355, 355-a, and/or 355-b) due to the commands 335-b and 345 being received first. In some examples, command 335-b can be received before command 345, hence it being entered into the global pool 327 first. In other examples, the command 335-b can be received before command 345 based on the first memory die queue 305 being associated with a higher priority level than the second memory die queue 305-a, or based on a random entry of commands associated with a same priority queue.

In some examples, command 350-b from the second priority queue 320-a of the third memory die queue 305-b can be the next command in the global pool 327. The command 350-b can be entered into the global pool based on it being received after the command 345 but before any commands associated with a higher priority (e.g., another command in a first priority queue). In some examples, the command 350-b can be entered into the global pool 327 before any other commands associated with a same priority level due to the command 350-b being received first.

In some examples, each of the remaining commands (e.g., commands 345-a, 345-b, 355, 355-a, and 355-b) can be entered into the global pool 327 last. In some examples, the commands can be entered based on an order received or based on a priority level associated with a respective memory die queue of each command. As discussed herein, each command in the global pool 327 can be issued by a local memory controller according to the order in which it is entered into the pool. Issuing commands in such an order (e.g., according to a respective priority level) can reduce backpressure that the local memory controller may otherwise incur, and may allow for the sub-system to issue commands based on available resources.

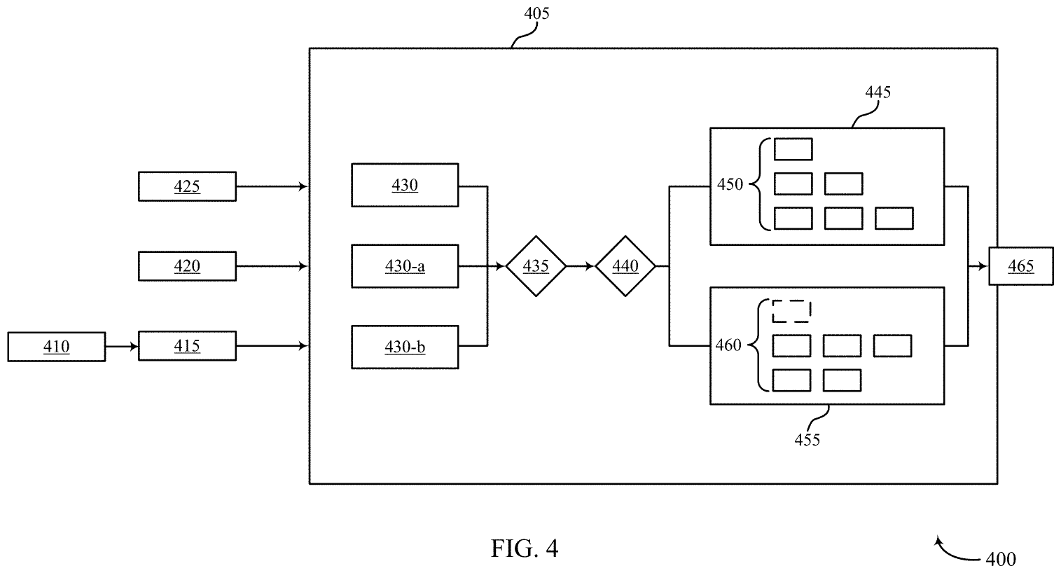

FIG. 4 illustrates an example of a memory system 400 for managing queues in accordance with some examples of the present disclosure. The memory system 400 can include a memory sub-system 405 that is coupled with a host device 410. In some examples, the host device 410 can communicate with the memory sub-system 405 through a processor 415. The host device 410 can also communicate with a read manager 420 (e.g., a read IO manager) and/or a write manager 425 (e.g., a write IO manager), which can both communicate with the memory sub-system 405. That is, the host device 410 can be coupled with the memory sub-system 405 via the processor 415, read manager 420, and/or the write manager 425. In some examples, the memory sub-system 405 can include one or more reception components (e.g., reception components 430, 430-a, 430-b), a memory die manager 435 (e.g., a LUN manager), a priority manager 440, and memory die queues 445 and 455 that correspond to one or more memory dies. In some examples, the memory sub-system can include more than two memory dies (and subsequently more than two memory die queues). Each memory die queue can include priority queues (e.g., priority queues 450 and 460) which can be examples of the priority queues discussed with reference to FIGS. 3A and 3B. In some examples, the priority queues 450 and 460 can issue commands (e.g., requests to complete associated commands) according to an associated priority. The requests can be entered into a global pool 465, where a local memory controller can then issue an associated command. The global pool 465 can be an example of the global pool 327 as discussed with reference to FIG. 3B.

The host device 410 can communicate with the memory sub-system 405 via the processor 415. In some examples, the host device 410 can transmit one or more commands (e.g., a host read, a host write) to the memory sub-system 405. The commands can be associated with particular memory cells (e.g., blocks of memory cells, memory dies, etc.) of the memory sub-system 405 and can be prioritized accordingly as discussed herein. In some examples, the read manager 420 can manage read operations (e.g., internal read operations) of the memory sub-system 405 and the write manager 425 can manage write operations (e.g., internal write operations) of the memory sub-system 405. The read manager 420 and the write manager 425 can each communicate with the host device 410 and/or the processor 415.

A command may be received by a reception component (e.g., reception component 430, 430-a, and/or 430-b) of the memory sub-system 405. As discussed above, commands can be received from the host device 410, the read manager 420, and/or the write manager 425. The reception component(s) can pass (e.g., transmit or send) the received command(s) to the memory die manager 435. In some examples, the memory die manager 435 can determine a particular memory die associated with the command. That is, the memory die manager 435 can determine a memory address associated with a received command. The memory die manager 435 can pass (e.g., transmit) the memory address associated with the received command to the priority manager 440.

The priority manager 440 can determine a priority level associated with a command. As discussed herein, certain commands (e.g., a host read command) can be associated with a first priority level and other commands (e.g., host write commands, read commands, write commands, erase commands, etc.) can be associated with a different priority level. The priority level of the command can determine the priority queue (of a memory die queue) that a command can be entered in. Thus the memory die manager 435 and the priority manager 440 can determine a memory die (e.g., an address of a memory die) associated with a command and ensure that the command is entered into a correct priority queue associated with the particular die. For example, the command can be entered into one of priority queues 450 or 460.

The memory die queues 445 and 455 can each include one or more priority queues. For example, priority queue 450 of memory die queue 445 can represent multiple priority queues as discussed with reference to FIG. 3A. Similarly, priority queue 460 of memory die queue 455 can represent multiple priority queues as discussed with reference to FIG. 3A. As shown in FIG. 4, priority queue 450 can include three priority queues (e.g., a first, second, and third priority queue) that include one, two, and three commands respectively. Additionally or alternatively, priority queue 460 can include three priority queues (e.g., a first, second, and third priority queue) that include zero, three, and two commands respectively. The commands can be issued (e.g., released) according to the respective priority level of each command and/or the order in which the commands are entered into the respective priority queues. Once the requests (e.g., the commands) are released, they can be entered into the global pool 465, where they can be issued by a local memory controller. Issuing the commands from the global pool 465 in an order received (i.e., according to the time the commands were received and the respective priority of each command) can reduce backpressure that the local memory controller may otherwise incur, and may allow for the sub-system to issue commands based on available resources.

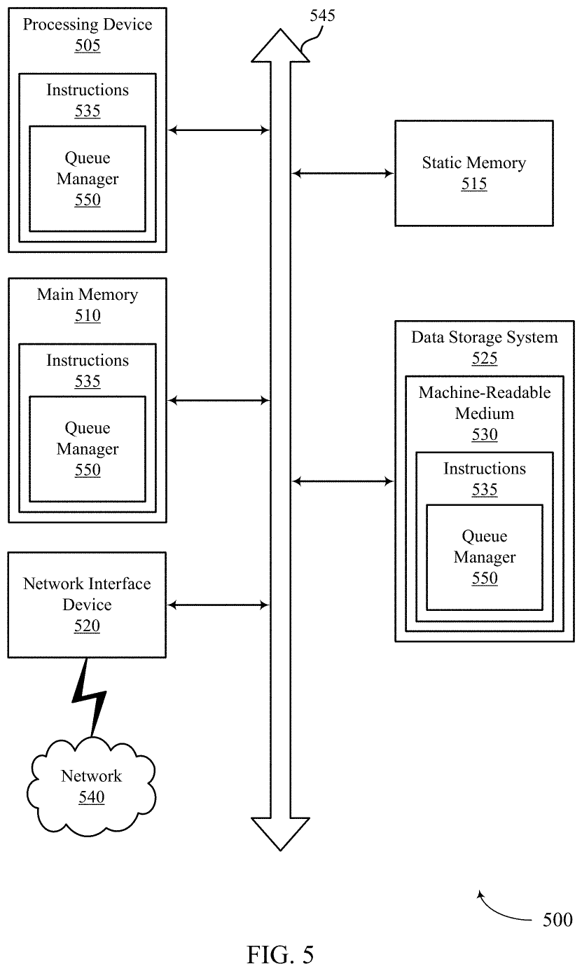

FIG. 5 illustrates an example machine of a computer system 500 that supports managing queues of a memory sub-system in accordance with examples as disclosed herein. The computer system 500 can include a set of instructions, for causing the machine to perform any one or more of the techniques described herein. In some examples, the computer system 500 can correspond to a host system (e.g., the host system 105 described with reference to FIG. 1) that includes, is coupled with, or utilizes a memory sub-system (e.g., the memory sub-system 110 described with reference to FIG. 1) or can be used to perform the operations of a controller (e.g., to execute an operating system to perform operations corresponding to the queue manager 150 described with reference to FIG. 1). In some examples, the machine can be connected (e.g., networked) with other machines in a local area network (LAN), an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” can also include any collection of machines that individually or jointly execute a set (or multiple sets) of instructions to perform any one or more of the methodologies discussed herein.

The example computer system 500 can include a processing device 505, a main memory 510 (e.g., ROM, flash memory, DRAM such as SDRAM or Rambus DRAM (RDRAM), etc.), a static memory 515 (e.g., flash memory, static RAM (SRAM), etc.), and a data storage system 525, which communicate with each other via a bus 545.

Processing device 505 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 505 can also be one or more special-purpose processing devices such as an ASIC, an FPGA, a DSP, network processor, or the like. The processing device 505 is configured to execute instructions 535 for performing the operations and steps discussed herein. The computer system 500 can further include a network interface device 520 to communicate over the network 540.

The data storage system 525 can include a machine-readable storage medium 530 (also known as a computer-readable medium) on which is stored one or more sets of instructions 535 or software embodying any one or more of the methodologies or functions described herein. The instructions 535 can also reside, completely or at least partially, within the main memory 510 and/or within the processing device 505 during execution thereof by the computer system 500, the main memory 510 and the processing device 505 also constituting machine-readable storage media. The machine-readable storage medium 530, data storage system 525, and/or main memory 510 can correspond to a memory sub-system.

In one example, the instructions 535 include instructions to implement functionality corresponding to a queue manager 550 (e.g., the queue manager 150 described with reference to FIG. 1). While the machine-readable storage medium 530 is shown as a single medium, the term “machine-readable storage medium” can include a single medium or multiple media that store the one or more sets of instructions. The term “machine-readable storage medium” can also include any medium that is capable of storing or encoding a set of instructions for execution by the machine and that cause the machine to perform any one or more of the methodologies of the present disclosure. The term “machine-readable storage medium” can include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some examples, a machine-readable (e.g., computer-readable) medium includes a machine (e.g., a computer) readable storage medium such as ROM, RAM, magnetic disk storage media, optical storage media, flash memory components, etc.

In the foregoing specification, examples of the disclosure have been described with reference to specific example examples thereof. It will be evident that various modifications can be made thereto without departing from the broader spirit and scope of examples of the disclosure as set forth in the following claims. The specification and drawings are, accordingly, to be regarded in an illustrative sense rather than a restrictive sense.

What is claimed is:

1. A method comprising:
assigning a first command to a first queue of a memory die of a memory sub-system, wherein the first queue is associated with a first priority level, and wherein the memory die includes a second queue associated with a second priority level different from the first priority level, the second queue comprising a second command, wherein the first command and the second command are each associated with a respective operation to be performed on the memory sub-system; and
issuing the first command before issuing the second command based at least in part on the first and second priority levels.

2. The method of claim 1, further comprising:
issuing one or more second commands in the second queue before assigning the first command to the first queue; and
suspending issuing of the one or more second commands in the second queue based at least in part on assigning the first command to the first queue, wherein issuing the first command is based at least in part on suspending issuing of the one or more second commands.

3. The method of claim 2, further comprising:
resuming issuing the one or more second commands in the second queue after issuing the first command.

4. The method of claim 3, further comprising:
assigning an additional first command to the first queue after resuming issuing the one or more second commands in the second queue;
suspending issuing the one or more second commands in the second queue based at least in part on assigning the additional first command to the first queue;
issuing the additional first command based at least in part on suspending the one or more second commands; and
resuming issuing the one or more second commands in the second queue after issuing the additional first command.

5. The method of claim 1, wherein the first queue includes one or more additional commands, the method further comprising:
issuing, based at least in part on assigning the first command, the one or more additional commands before issuing the one or more second commands in the second queue.

6. The method of claim 1, further comprising:
assigning first commands to a plurality of first queues of a plurality of memory dies of the memory sub-system, wherein each of the plurality of first queues is associated with the first priority level and wherein each of the plurality of memory dies includes a respective second queue associated with the second priority level; and
issuing each of the first commands before issuing commands in respective second queues of the plurality of memory dies based at least in part on the first and second priority levels.

7. The method of claim 1, further comprising:
determining an amount of resources available to the memory sub-system, wherein issuing the first command before issuing the one or more second commands in the second queue is based at least in part on the amount of resources available to the memory sub-system.

8. The method of claim 1, wherein the first command comprises a host read command, and wherein the one or more second commands comprise a host write command, a read command, a write command, an erase command, or a combination thereof.

9. A system comprising:
a plurality of memory components; and
a processing device, operatively coupled with the plurality of memory components, to:
assign, to a first queue of a memory die of a memory sub-system, a first command associated with a first priority level, wherein the memory die comprises a second queue associated with a second priority level different than the first priority level; and
transmit the first command before a second command included in the second queue based at least in part on the first and second priority levels.

10. The system of claim 9, further comprising:
the processing device further to:
transmit one or more second commands from the second queue before assigning the first command to the first queue; and
suspend transmission of additional second commands included in the second queue based at least in part on assigning the first command to the first queue, wherein issuing the first command is based at least in part on suspending transmission of the additional second commands.

11. The system of claim 10, further comprising:
the processing device further to:
transmit additional second commands included in the second queue after issuing the first command.

12. The system of claim 11, further comprising:
the processing device further to:
assign an additional first command to the first queue after resuming transmission of the additional second commands included in the second queue;
suspend transmission of one of the additional second commands in the second queue based at least in part on assigning the additional first command to the first queue;
transmit the additional first command based at least in part on suspending transmission of one of the additional second commands; and
transmit the one of the additional second commands in the second queue after transmitting the additional first command.

13. The system of claim 9, wherein the first queue includes one or more additional first commands:
the processing device further to:
transmit, based at least in part on assigning the first command, the one or more additional first commands before transmission of one or more second commands included in the second queue.

14. The system of claim 9, further comprising:
the processing device further to:
assign first commands to respective first queues of a plurality of first queues of a plurality of memory dies of the memory sub-system, each of the first commands associated with the first priority level, wherein each of the plurality of memory dies comprises a second queue associated with a second priority level; and
transmit each of the first commands before transmitting one or more second commands in the second queues of the plurality of memory dies based at least in part on the first and second priority levels.

15. The system of claim 9, further comprising:
the processing device further to:
determine resources available to the memory sub-system; and
issue the first command before issuing one or more second commands in the second queue based at least in part on the resources available to the memory sub-system.

16. A non-transitory computer-readable storage medium comprising instructions that, when executed by a processing device, cause the processing device to:
assign a first command to a first queue of a memory die of a memory sub-system, wherein the first queue is associated with a first priority level, and wherein the memory die includes a second queue associated with a second priority level different from the first priority level, the second queue comprising a second command, wherein the first command and the second command are each associated with a respective operation to be performed on the memory sub-system; and
issue the first command before issuing the second command based at least in part on the first and second priority levels

17. The non-transitory computer-readable storage medium of claim 16, wherein the processing device is further to:
issue one or more second commands in the second queue before assigning the first command to the first queue; and
suspend issuing of the one or more second commands in the second queue based at least in part on assigning the first command to the first queue, wherein issuing the first command is based at least in part on suspending issuing of the one or more second commands.

18. The non-transitory computer-readable storage medium of claim 17, wherein the processing device is further to:
resume issuing the one or more second commands in the second queue after issuing the first command.

19. The non-transitory computer-readable storage medium of claim 18, wherein the processing device is further to:
assign an additional first command to the first queue after resuming issuing the one or more second commands in the second queue;
suspend issuing the one or more second commands in the second queue based at least in part on assigning the additional first command to the first queue;
issue the additional first command based at least in part on suspending the one or more second commands; and
resume issuing the one or more second commands in the second queue after issuing the additional first command.

20. The non-transitory computer-readable storage medium of claim 16, wherein the first queue includes one or more additional commands, and wherein the processing device is further to:
issue, based at least in part on assigning the first command, the one or more additional commands before issuing the one or more second commands in the second queue.
